(19) United States
(12) Patent Application Publication
(10) Pub. No.: US 2004/0150881 A1
(43) Pub. Date: Aug. 5, 2004

(54) Motor focus for telescope

(76) Inventors: Dirk Luthardt, Wetzlar (DE); Karlheinz Bartzke, Jena (DE)

Correspondence Address: M. Robert Kestenbaum, 11011 Bermuda Dunes NE, Albuquerque, NM, 87111, US

(21) Appl. No.: 10/740,884

(22) Filed: Dec. 17, 2003

(30) Foreign Application Priority Data
Dec. 20, 2002 (DE) DE 102 59 929.7
Mar. 25, 2003 (DE) DE 103 13 184.1

(51) Int. Cl. G02B 23/00

(52) U.S. Cl. 359/399

(57) ABSTRACT

A telescope has an optical axis established by the optical elements of the telescope and at least one lens mounted displaceably along the optical axis. A motorized drive is provided for driving the at least one displaceably mounted lens.

### CROSS-REFERENCES TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

1. Field of the Invention

The invention relates to a telescope with an optical axis established by the optical elements of the telescope and with at least one lens mounted displaceably along the optical axis.

2. Related Art

From EP 589 177 B1, there is known a monocular telescope of constant length with an objective arranged in a tube, and an interchangeable or variable eyepiece for changing the magnification. This telescope is provided with an adjusting member by means of which a focusing unit displaceably mounted in the tube can be displaced along the optical axis. This monocular telescope includes an adjusting unit which is formed as a gear transmission with plural different gears, selectable according to the magnification used. The adjustment speed of the focusing unit can be matched to the selected magnification by means of this adjusting member.

From DE 1 243 405, a geodetic aiming telescope is known, in which an adjusting mechanism was adapted to the optical conditions for sharp imaging. Accordingly, the adjustment speed of the focusing lens does not take place linearly for actuation of the actuating element provided for focusing.

A telescope with a fine adjustment nut is furthermore known from DE 1 109 398 AS. From U.S. Pat. No. 4,632,547 an alignment telescope is known which is provided with a change gear so that the focusing lens can be selectively displaced slowly and sensitively, or rapidly.

### SUMMARY OF THE INVENTION

The present invention has as its object to provide a comfortably operable telescope, particularly a monocular telescope.

By the measure of providing the telescope according to the invention with a motorized drive, by means of which at least one lens can be driven, mounted displaceably along the optical axis, a comfortably operable telescope can be provided.

This motorized drive can be provided both for driving a focusing unit and also for driving an adjustable variable magnification of the telescope. A changeover between the lenses or lens groups to be driven can be effected by means of a coupling.

It can be provided that a focusing can be performed automatically, so that, for example, the telescope is focused on an object appearing in the middle of the image field.

It has been found according to the invention to allocate an operating element to the motorized drive for its control, so that a setting of the magnification or focusing can be effected by actuation of this actuating element as desired by the user.

It has been found according to the invention to provide as the operating element, an operating element which can be actuated in two directions. By actuating in a first direction, the at least one lens displaceable by means of this drive is driven in a first direction, and on actuating in the opposite direction is correspondingly driven in the opposite direction.

It has furthermore been found according to the invention to provide an operating element which has plural discrete actuating positions. It is thereby possible to allocate different drive speeds to these discrete actuating positions.

It has furthermore been found according to the invention to provide an operating element which can be operated continuously, so that the drive speed can be selected continuously by corresponding actuation of the operating element.

It has been furthermore found according to the invention to provide the actuating element with a sensor. It is thereby possible to drive the motorized drive in dependence on the sensed actuation position of the operating element.

It has furthermore been found according to the invention to provide a control device to which the sensor signals are supplied. The motorized drive is driven in dependence on the supplied signals by the control device. The desired speed and direction are taken into account here,

By the use of the at least one sensor, signal leads, particularly connections conducting electrical signals, can be used, which can be arranged to save space in comparison with a mechanical transmission. Constructional space can thus be better used. The arrangement of the control device is flexibly selectable. Signal connections can be provided very flexibly and are very space-saving.

As an embodiment of the operating element, it has been found satisfactory to provide as the operating element a tilting switch, tilting key, or sliding key. Control of the drive speed can be provided in dependence on the amount of deflection of this tilting switch.

It has been found according to the invention that the lens displaceable along the optical axis is arranged between the eyepiece and the objective. Standard eyepieces and objectives can thereby also be used without modification in such a telescope with motorized drive. These standard eyepieces and objectives are often interchangeable.

### BRIEF DESCRIPTION OF THE DRAWINGS

The invention is described in detail using the following embodiment examples.

FIG. 1 shows a monocular telescope,

FIG. 2 shows a section through a telescope with motorized drive for driving an axially displaceable lens,

FIG. 3 is a sketch of a telescope with operating element, with sensor and emergency actuation,

FIG. 4 shows a diagram of the changeover mechanism between the motorized drive and the emergency actuation,

FIG. 5 shows a side view of the changeover mechanism shown in FIG. 4,

FIG. 6 shows a side view of a telescope with a linear motor as the drive,

FIG. 7 shows a sensor with indicator disk,

FIG. 8 is a diagram of the sensitivity of the actuating element.

### DETAILED DESCRIPTION OF THE INVENTION

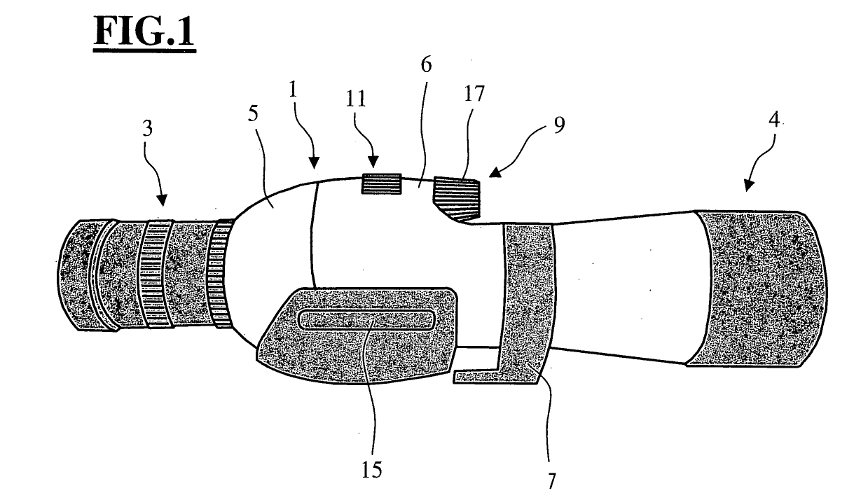

The principal construction of a monocular telescope, also termed a monocular or an observation telescope, is first described using FIG. 1. This monocular comprises a motorized drive for driving displaceably mounted lenses along the optical axis. The monocular furthermore comprises an objective 4 and an eyepiece 3. The eyepiece (3) can be interchangeable. A variable eyepiece can also be provided as the eyepiece. A middle housing portion 6 and a forward housing portion 5 are arranged between the objective 4 and the eyepiece 3. The middle housing portion is provided with a stand fastening 7. A grip region is formed on the underside of the monocular and comprises grip grooves 15. An operating element 11 and a rotary knob 17 are arranged on the side opposite to the grip grooves, and thus on the side of the monocular 1 facing the horizon in use. The operating element 11 is allocated to a motorized drive 20, not shown in FIG. 1. The rotary knob is a component of the manual drive designated as the emergency actuation 9. The invention described in what follows using the described embodiment examples can in particular also be used for binocular telescopes.

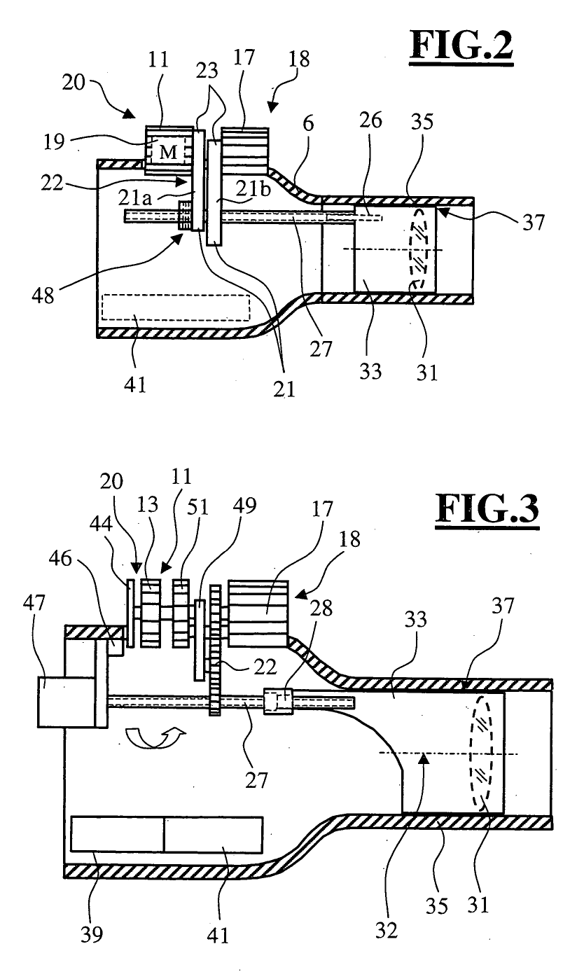

The detailed construction relating to the motorized drive 20 and the emergency actuation 18 is described in detail using FIG. 2. A spindle 27 with an external thread is formed in the middle housing portion 6. This spindle 27 is fixedly connected to a mount 33 by means of a rod. This mount 33 is displaceably mounted by means of an axial guide 37 for displacement along the axis of the monocular. A nut 48 is in engagement with the spindle, and is mounted in the middle housing portion, rotatably but axially fixed. This nut 48 can be driven rotationally via a gear stage 21, here via a toothed belt 23.

However, it is also possible to use a spindle with an internal thread and then in engagement with a rod with an external thread. The rod is then fixedly connected to the mount 33, the mount 33 again being mounted rotatably fixed and axially displaceable. The spindle is mounted axially fixed and rotatable. A translational movement of the mount 33 thereby results from a rotary drive of the spindle.

A threaded rod 26 is in engagement with the thread of the spindle 27. This threaded rod 26 is fixedly connected to a mount 33. The mount 33 is mounted displaceably in the axial direction, i.e., along the optical axis of the monocular 1, by means of an axial guide 37. A lens 31, which is thus mounted axially displaceably, is arranged in this mount 33. In the embodiment example shown, only one lens is shown by way of example; however, a lens group consisting of plural lenses could be mounted axially displaceably by means of the mount.

The mount 33 is mounted axially displaceably in a tube 35 by means of a longitudinal toothing or other guide element. A motor 19 is provided for driving the spindle and is operatively connected to the spindle via a gear 22. In this embodiment example, the motor 19 is arranged within the operating element 11. Batteries or an accumulator 41 are arranged in the lower region in the middle housing portion 6 for energy supply of the motor 19. The energy for recharging the accumulator 41 can be provided by means of a solar surface arranged on the housing 5, 6.

The rotary knob 17 of the manual drive 18 is operatively connected with the spindle 27 via the gear 22, which comprises a further gear stage 21b. This emergency actuation 9, or this manual drive, is provided for the case that the motor drive 20 is not able to function or is unsuitable because of the noise connected with the motorized drive. The two gear transmission stages 21a and 21b are formed with different transmission ratios. To activate the emergency actuation 18, the rotary knob is to be pulled out in the direction of the objective 4, closing a provided coupling 49. The movement initiated by the rotary knob 17 is thereby transmitted via the gear stage 21b to the spindle 27.

Such changeover systems as the coupling 49 and the systems shown hereinafter can also be provided for a changeover between driving a selectable magnification and driving a focusing, the motor being either in operative connection to the focusing lens or to the displaceable lens for setting the desired magnification.

In a simplified embodiment, the coupling can also be dispensed with. In such an embodiment, basically a movement of the rotary knob 17 is also connected with a drive of the operating element 11.

In a simplified embodiment, the emergency actuation can be dispensed with, so that driving the axially displaceable lens is not possible on failure of the motor.

A further alternative embodiment of a telescope or monocular, including a motorized drive 20 and an emergency actuation, is described in detail using FIG. 3.

In this embodiment example, the operating element 11 is formed as a tilting switch 13. A sensor is allocated to this tilting switch 13, and detects the deflection of the tilting switch 13. This sensor 45 comprises a sensor disk 44 which is fixedly connected to the tilting switch 13. The deflection of the sensor disk 44 is detected by a detector 46. The signals of the detector 46 are supplied to a control device 39. A stepping motor, directly connected to the spindle 27, is controlled for driving the spindle in dependence on the signals. The signal connections are not shown in FIG. 3 for the sake of clarity.

The energy supply 41 is again arranged in the lower region of the middle housing portion 6. The control device 39 is also arranged in this region. Because of the possibility of being able to flexibly arrange the signal connections, it is however possible to arrange the control device at another not yet filled location in the monocular. Constructional spaces already present can thus be optimally used.

The arrangement of the batteries in the lower housing region contributes to an advantageous weight distribution for handling, which is to be considered as far as possible.

In this embodiment example, the spindle 27 has an external thread, which is in engagement with a nut 28. The nut is fixedly connected to the mount 33, which is axially displaceably mounted in the tube 35 by means of an axial guide 37 in the form of a longitudinal toothing or other kind of axial guide. Because the nut is mounted axially fixed and in engagement with the spindle, there results an axial movement of the mount 33 along the optical axis 32 due to the rotary drive of the spindle. A lens 31 mounted by means of the mount 33 is again shown by way of example.

Embodiment alternatives of the tilting switch 13 provided are set out hereinafter. In all the alternatives of a tilting switch discussed below, they automatically return to the inoperative position on reduction of a force acting from externally on the tilting switch. Starting from this inoperative position, the tilting switch 13 can be deflected in a first direction which drives the motor 19 to drive the spindle in a first direction. If the tilting switch is deflected in the opposite direction, the motor 19 is driven to drive the spindle 27 in the opposite direction.

In a first embodiment of a tilting switch 13, it is provided that this tilting switch 13 has plural discrete actuating positions. These actuating positions are signaled to the user, in that the user has to overcome a resistance from one actuating position into a neighboring actuating position. The tilting switch 13 automatically returns to the inoperative position on ending the actuation. These discrete actuating positions are allocated to predetermined drive speeds, that is, specific reference speeds of the motor 19. The greater the deflection angle of the actuating element, the faster the axially displaceable lens is driven. The drive speed can thus be set stepwise. This stepping is preferably embodied so that only a slight change of the drive speed is connected with small deflections of the tilting switch, considering the absolute speeds.

Furthermore, a tilting switch can be provided which can be deflected continuously in a first direction and in an opposite direction. The respective deflection of the tilting switch 13 is detected by a sensor and supplied to the control device 39. By means of this control device 39, the motor is driven n dependence on the amount of the detected deflection, the drive speed of the motor continuously increasing with increasing deflection of the tilting switch. It can also be provided that a stepwise increase of the rotational speed of the motor 19 can be driven by the control device. In dependence on the direction of the deflection of the tilting switch 13, the motor is driven in a first or a second direction.

The embodiment example shown in FIG. 3 is also provided with an emergency actuation 18. By means of a changeover coupling, the motorized drive 20 can be changed over with the motor 47 to manual driving by turning the rotary knob 17. A switch element 51 is provided for changing over. If the emergency actuation is activated by changing over the switch element 51, a drive wheel fixedly connected to the rotary element 17 is placed in operative connection with the spindle 27 via a gear 22. A rotation of the spindle 27 accordingly results from a rotation of the rotary element 17. Suitable as the gear 22 are toothed belt drives in particular, as shown in FIG. 2, CVT drives with belt and gear including interengaging gear wheels, see FIG. 3.

It is also ensured by the coupling 49 that with motorized drive the rotary knob 17 does not also turn. Furthermore, in the case of an emergency actuation, the force required for emergency actuation is reduced by decoupling the motorized drive, since the motor must not also be turned. The force flux can be interrupted by means of a switch coupling. Numerous examples of this are known from the literature, for example from “Construction elements of fine mechanisms”, Chapter 11.4.2, 2d. edition, Hansa Publishing, authors Werner Krause, or “Basics of construction”, 7th. edition, Hansa Publishing, by Werner Krause, pages 218-219. Furthermore, with the motorized drive, the drive chain (rotor axis of the motor flange, spindle, spindle nut) can be interrupted, and an be supplemented by an additional transmission element. This additional transmission element is designed so that if necessary there is a frictional or positive connection between the other transmission members. The drive chain is interrupted by pivoting the additional transmission in and out, and the motorized drive is thus decoupled. Basically this is also in the effective principle of a switch coupling.

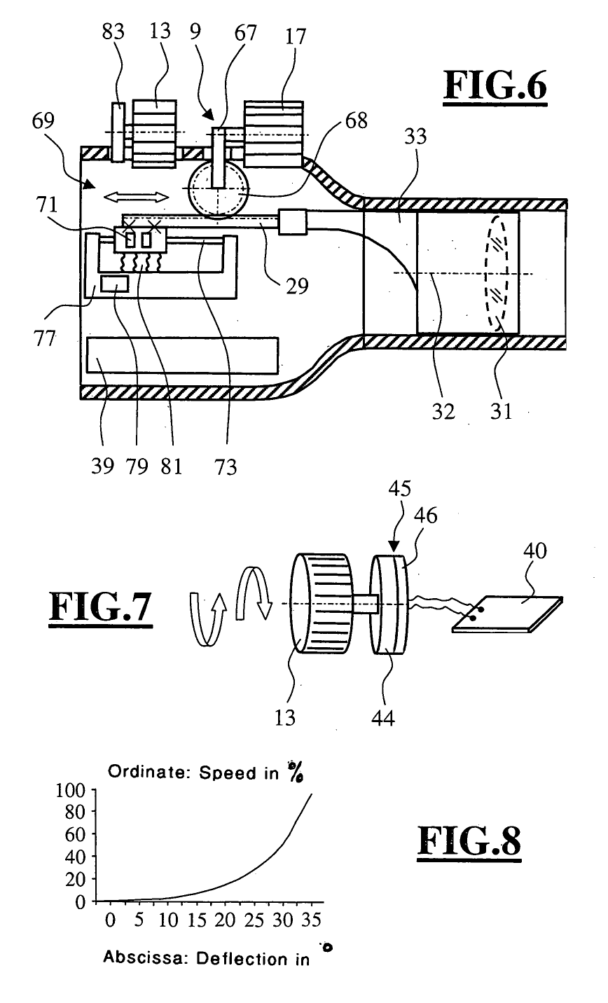

An embodiment example is shown in FIG. 6 in which the motorized drive 20 comprises a linear drive 69. This linear drive has a slide 71. This slide includes electromagnets 75. This slide 71 is guided by a slide guide 73 and is fixedly connected to the rack 29. The linear drive 69 furthermore includes a stator 77 of the permanent magnet 79. The linear motor 69 is effectively connected to a rack 29. By driving the linear drive 69, the rack 29 is displaced in the axial direction. This rack 29 is fixedly connected to the mount 33 acting to mount the axially displaceable lenses 31. A tilting switch 13 is again provided as the operating element 11, its actuation position being detected by a sensor 83. The signal of this sensor 83 is supplied to the control unit 39. In dependence on these signals, the control unit 39 drives the linear motor, so that a movement of the lens results in the axial direction along the optical axis 32.

This embodiment example is also provided with an emergency actuation, so that on the one hand in dependence on the use situation and on the other hand when there is a defect in the motorized drive, the possibility exists of moving the lens 31 along the optical axis by manual actuation of the rotary knob 17. This emergency actuation 9 includes a switchable gear 67. By pulling out the rotary knob 17, the rotary knob is connected to the rack via the switchable gear 67. A rotary movement of the rotary gear 68, which is connected to the rack 29, then results from a rotary movement of the rotary knob 17. The lens is displaced upon movement of the rack.

The function of the tilting switch 13, which is provided with an advantageous sensor, is once again described using FIG. 7. The tilting switch is held in a defined inoperative position, preferably in the middle position. Upon deflection of the operating knob to left or right, the sensor disk 44 is correspondingly also turned. This sensor disk 44 is then rotated against an indicator disk 46. A signal is generated by this indicator disk 46 and corresponds to the deflection of the tilting switch 13. This signal acts as a control level for a motor control contained in the control device. The motor then moves forward or backward with a speed allocated to the control level. This means that the greater is the deflection at the tilting switch, the greater the rotational speed of the motor in the corresponding direction. If the tilting switch 13 is released, it returns again to the defined starting position. In this starting position, deflection equal to 0 and control level equal to 0, the motor is stationary. If an actuation has not occurred after a given period, the motor is preferably switched off and is first brought into a readiness position again with the next actuation.

Instead of the above-described sensor system, a potentiometer could also act for conversion of the deflection. Alternatively, the use of other sensors, for example reed contacts, Hall sensors, optical sensors, etc. is conceivable and possible. A direction changeover can also be effected by the operating element, for example with a provided pressure element by actuation twice in rapid succession. The motor control is formed as a plate 40 in FIG. 7.

A particularly advantageous dependence of deflection on resulting drive speed of the movable lens is shown in FIG. 8. In the region of small deflections of the rotary knob 11, up to about 10°, a small increase of the driving speed takes place. The driving speed can thus be chosen very sensitively at low drive speeds. At high drive speeds, where a rapid drive speed is desirable, a large effect on the drive speed of the displaceably mounted lens can be attained.

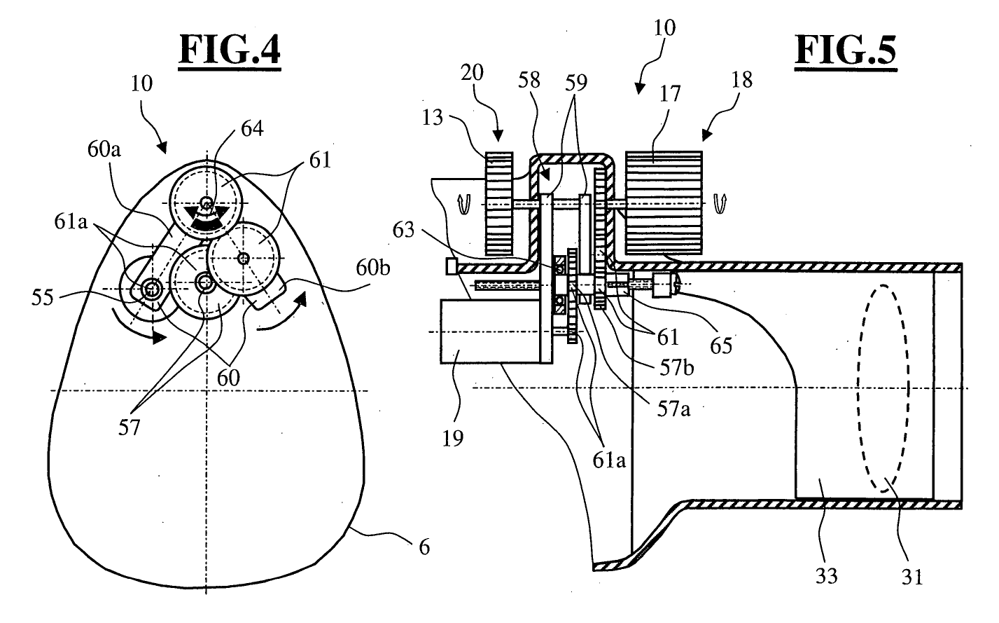

A further embodiment of a drive unit for a lens mounted displaceably along the optical axis is shown in FIGS. 4 and 5. This drive unit 10 also includes a motorized drive 20 and an emergency actuation 18 for driving the lens mounted displaceably along the optical axis, particularly the focusing lens or the focusing lens group. For changing over from a motorized drive to a drive by means of the emergency actuation, a switch gear is provided. This switch gear 58 comprises an angle element 59 with two legs 60. This angle element 59 is rotatably mounted about a rotation axis in the plane spanned by the two legs. The angle between the two legs then remains unchanged upon a rotary movement of the angle element 59. The motor 19 is fixedly connected to one leg 60a. The drive shaft of the motor 19 has a gearwheel 55.

A spindle is connected rotationally fixed to the mount 33, which is mounted radially fixed but axially displaceably in the tube 35. A claw nut 65 is mounted on this spindle, rotatably but however axially fixed relative to the housing 6 of the monocular. A ball bearing 63 is provided for this mounting. This claw nut 65 carries a double gearwheel 57, the one gearwheel having a large diameter 57a and the other gearwheel a small diameter 57b. If the motorized drive 20 is activated, the gearwheel 55 of the motorized drive, here the electric motor, is engaged with the double gearwheel 57a with large diameter. According to FIG. 4, the pinion 55 is just out of engagement with the double gearwheel with greater diameter 57a. The switch position in which an axial displacement of the lens 31 along the optical axis by means of the emergency actuation 18 is possible is shown in FIG. 4.

The driving of the lens 31 by means of the emergency actuation is described in detail hereinafter. A gearwheel of a gearwheel pair 61 is fixedly connected to the rotary knob 17. This gearwheel is engaged with the second gearwheel of the gearwheel pair 61, which is rotatably mounted on the leg 60b. This second gearwheel on the leg 60b is in its turn engaged with the gearwheel 57b of the double gearwheel, as shown in FIG. 4. By pivoting the angle element as shown by the arrow 64, switching can be effected between active motorized drive and emergency actuation. The angle element 59 is fixedly connected to the rotation axis. The rotation axis is rotatably mounted in the housing, and is not axially displaceable. An operating element (tilting switch 13) is fixedly connected to this rotation axis. With this operating element, the user can rotate the rotation axis and thus pivot the angle lever (angle element 59) around the rotation axis. It is conceivable that the angle lever is held in a defined manner in both engagement positions. For example, by means of a spring, or by means of another tilting jump mechanism, as already known from the literature, for example, “Construction elements of fine mechanisms” by Werner Krause, Chapter 12.3.2, 2d. edition, Hansa Publishing.

Instead of the rotary elements used in the embodiment examples shown for the actuation of emergency actuation and motorized drive, a sliding element could also be used, with which the motorized drive is driven in dependence on the occurring deflection, or upon an emergency actuation, this sliding movement corresponds to the movement of the lens 31. Such an emergency actuation could also still be provided with a conversion gear, so that a sensitive displacement of the lens 31 is also possible by means of the emergency actuation.

The use of pressure switches and key switches is also possible.

List of Reference Numerals

1 telescope 29 rack

3 eyepiece 31 displaceable lens

4 objective 32 optical axis

5 forward housing portion 33 mount

6 middle housing portion 35 tube

7 stand fastening 37 axial guide

9 emergency actuation 39 control device

10 drive unit 40 control plate

11 operating element 41 battery/accumulator

13 tilting switch 44 sensor disk

15 grip grooves 45 sensor

17 rotary knob 46 indicator disk

18 emergency actuation/manual drive 47 stepping motor

19 motor 48 nut

20 motorized drive 49 coupling

21 gear stage 51 switch element

22 gear 55 gearwheel

23 toothed belt 57 double gearwheel

25 pinion 59 angle element

26 threaded rod 60 leg

27 spindle 61 gearwheel pair

28 nut 63 ball bearing

65 claw nut with double gearwheel 75 electromagnet

67 switchable gear 77 stator

68 gearwheel 79 permanent magnet

69 linear drive 81 magnetic field

71 slider 83 sensor

73 slider guide

We claim:

1. Telescope with an optical axis established by optical elements of the telescope comprising at least one lens mounted displaceably along the optical axis, and a motorized drive (20) the at least one displaceably mounted lens (31).

2. Telescope according to claim 1, further comprising an operating element (11) allocated to the motorized drive (20).

3. Telescope according to claim 2, wherein the operating element (11) comprises an operating element (13) deflectable in two directions, starting from an inoperative position.

4. Telescope according to claim 2, wherein the operating element (11) has plural discrete actuating positions.

5. Telescope at least according to claim 2, wherein the operating element (11) provides continuous actuation up to a maximum deflection.

6. Telescope according to claim 1, wherein the motorized drive (20) comprises a motor (19) which is driven at different drive speeds.

7. Telescope at least according to claim 2, wherein the operating element (11) comprises a sensor for detecting an actuating position.

8. Telescope according to claim 6, comprising a control device (39) for controlling speed and direction of the motorized drive (20) or of the motor (19).

9. Telescope at least according to claim 2, further comprising a tilting switch (13) as the operating element (11).

10. Telescope at least according to claim 1, wherein the at least one displaceable lens (31) comprises a focusing lens.

11. Telescope according to claim 10, wherein the focusing lens is arranged between an eyepiece (3) and an objective (5).

12. Telescope according to claim 1, wherein a lens provided for setting the magnification of the telescope is driven by means of the motorized drive (20).

13. Telescope according to claim 1, wherein the motorized drive (20) is selectively coupled by means of a changeover element to the displaceably mounted lens for magnification setting or to a focusing lens.

14. Telescope according to claim 1, further comprising a manual drive (18), for driving the displaceably mounted lens (31).

15. Telescope according to claim 14, further comprising coupling (49) for selectively driving the displaceable lens (31) by means of the motorized drive (20) or by means of the manual drive (18).

16. Telescope at least according to claim 2, wherein a drive direction of the motorized drive (20) is established in relation to a selected actuation of the operating element (11).

17. Telescope according to claim 1, wherein the motor (19) comprises linear drive (69).

18. Telescope according to claim 2, wherein a drive speed of the motorized drive (20) increases at least as a square, in proportion to a deflection from an inoperative position.

19. Telescope according to claim 18, wherein the drive speed increases exponentially.

20. Telescope according to claim 18, wherein a maximum speed is predetermined.

21. Telescope according to claim 8, wherein the at least one displaceable lens (31) is displaceable between two predetermined end positions and the speed of the motorized drive is controlled in dependence on a position of the at least one displaceable lens (31).

22. Telescope according to claim 21, wherein the speed is throttled in a predetermined distance before reaching an end position with a speed exceeding a threshold value.
